(19) United States
(12) Patent Application Publication
(10) Pub. No.: US 2005/0217471 A1
(43) Pub. Date: Oct. 6, 2005

(54) Ceramic antiballistic layer, process for producing the layer and protective device having the layer

(75) Inventor: Bodo Benitsch, Buttenwiesen (DE)

Correspondence Address: LERNER AND GREENBERG, PA, P O BOX 2480, HOLLYWOOD, FL, 33022-2480, US

(73) Assignee: SGL Carbon AG

(21) Appl. No.: 10/988,735

(22) Filed: Nov. 15, 2004

(30) Foreign Application Priority Data
Nov. 25, 2003 (EP) 03 027 067.3

(51) Int. Cl. B32B 9/00

(52) U.S. Cl. 89/36.02

(57) ABSTRACT

A ceramic antiballistic layer which can be produced as a large-area, optionally curved component is able to withstand a multi-hit attack from hits spaced apart by a short distance at the target. The ceramic antiballistic layer has a continuous surface on a side which faces the attack, whereas a surface which faces away from the attack has a segmented structure. The segmented structure starts from the surface and extends into the interior of the protective layer but does not penetrate all the way through the layer as far as the opposite surface, which faces the attack. Processes for producing such a layer and a protective device having the layer are also provided.

### BACKGROUND OF THE INVENTION

### FIELD OF THE INVENTION

The invention relates to a ceramic antiballistic layer for protecting people and objects, for example vehicles, from attack, in particular a multi-hit attack, as well as other mechanical loads which act in a punctiform manner. The invention also relates to a protective device having the layer and processes for producing the layer.

In antiballistic systems, in addition to a minimal weight per unit area and a capacity to stop or destroy a projectile core, it is in particular the ability to withstand a series of direct hits, possibly close together, without being penetrated, that also plays a role. A conventional ballistic material is steel in specific alloy forms. Those alloys are able to withstand multi-hit impacts even spaced apart by distances of just approximately three calibers. The major drawback of such systems is their weight per unit area based on the ballistics resistance class of, for example, approximately 70 kg/m² for bullet resistance class FB 7. By contrast, ceramic materials have a higher antiballistic action based on density and weight per unit area (approximately 35-45 kg/m²) . However, due to the large-area and total failure properties of conventional monolithic ceramics, armor-plating of that type is not able to withstand a multi-hit impact spaced apart by a distance of approximately three calibers.

One solution to that problem resides in constructing armor-plating of that type from discrete ceramic segments, known as tiles, with lateral dimensions on the order of magnitude of 100 mm×100 mm to 20 mm×20 mm. In the event of a direct hit, only the affected tile is destroyed, whereas the surrounding system, which is decoupled from the tile by a gap between the adjacent tiles, remains substantially unaffected. The surface area destroyed corresponds to the size of the affected tile. Armor-plating of that type, composed of individual tile-like plating elements, is known, for example, from German Published, Non-Prosecuted Patent Applications DE 39 40 623 A1 and DE 198 34 393. The armor plating disclosed by German Published, Non-Prosecuted Patent Application DE 39 40 623 A1 includes individual plating elements, preferably ceramic tiles, which are joined to a protective backing, for example a high-modulus material including aramid fibers, through the use of an adhesive. According to that prior art, the exposed surface of a plating element is elevated toward the direction in which the projectile hits it and drops toward the edges of the plating element. By way of example, the exposed surface may be constructed as part of a surface of a sphere or as a frustopyramidal or frustoconical surface. As a result, a projectile which hits the plating element is deflected laterally, and its impact area is increased and the armor-piercing action is reduced.

International Publication No. WO 91/07632 discloses a plating including:
(a) a hard impact layer having at least one ceramic body, preferably a plurality of ceramic bodies, which are constructed as tiles;
(b) devices composed of an elastic material which retain the hard impact layer at the edge, with those devices being disposed around the edge of the impact layer and being joined to the impact layer; and
(c) devices composed an elastic material for retaining the (at least one) ceramic body, with those devices being disposed around the edge of each of the ceramic bodies which form the hard impact layer and forming a connected network of the elastic material.

The ceramic bodies are fixed to a backing layer which supports the impact layer and offers additional ballistic protection.

Suitable materials for that layer include metals and thermoplastic and thermosetting polymers which, if appropriate, are fiber-reinforced.

In one embodiment, that side of the layer composed of individual ceramic bodies which faces the attack is provided with a covering layer. The covering layer protects against splinters and is made from one of the materials which can also be used to produce the backing layer.

German Published, Non-Prosecuted Patent Application DE 198 34 393 A1 describes a plate element formed of a ceramic material for an antiballistic device which on at least one of its surfaces—i.e. on the side facing the attack or on the side facing away from the attack or on both sides—is provided with individual recesses which are spaced apart from one another by webs of material. That reduces the weight of the armor plating. Moreover, if the recesses are disposed on the side facing the attack, the momentum of the projectile striking it is deflected to the protruding webs of material and thereby largely eliminated. It is preferable for the recesses to be disposed in such a way that the webs which remain in place form a grid pattern.

In order to ensure that the destruction caused is decoupled even in the event of hits spaced apart by a short distance, the size of the tiles must be correspondingly reduced. That increases the costs of armor plating of that type. In particular, the production of singly or multiply curved components from individual tiles is very complex, since each tile has to be produced to match their individual geometry.

### SUMMARY OF THE INVENTION

It is accordingly an object of the invention to provide a ceramic antiballistic layer, a process for producing the layer and a protective device having the layer, which overcome the hereinafore-mentioned disadvantages of the heretofore-known devices and processes of this general type and in which the ceramic antiballistic layer can be produced as a large-area, optionally curved component and is able to withstand a multi-hit attack even spaced apart by short distances at the target.

With the foregoing and other objects in view there is provided, in accordance with the invention, an antiballistic layer. The antiballistic layer comprises at least one ceramic material and has a layer thickness. A side intended to face toward an attack has a continuous surface. A side intended to face away from the attack has a segmented surface composed of individual segments delimited by gaps. The gaps have a depth between the segments being at least 0.15 mm less than the layer thickness.

With the objects of the invention in view, there is also provided a process for producing an antiballistic layer. The process comprises producing the gaps by a material-removing process or by cutting at an intermediate stage of a production process or in a final process step, or by stamping, imprinting or pressing.

With the objects of the invention in view, there is additionally provided a process for producing an antiballistic layer which comprises inserting, pressing or casting spacers into still-deformable ceramic material at locations at the surface to be segmented at which the gaps are to be produced. The ceramic material is consolidated and the spacers are removed.

With the objects of the invention in view, there is furthermore provided a process for producing an antiballistic layer which comprises producing a structure of the segmented surface by forming cracks on one side of a green body as the green body dries.

With the objects of the invention in view, there is also provided a process for producing an antiballistic layer, which comprises joining the first and second layers of ceramic materials having different coefficients of thermal expansion in a process taking place at elevated temperature. The material of the second layer has a higher coefficient of thermal expansion than the material of the first layer. The antiballistic layer is cooled immediately after the first and second layers have been joined or layered together, forming segmenting cracks in the second layer.

With the objects of the invention in view, there is concomitantly provided a protective device. The protective device comprises the antiballistic layer for protecting people, vehicles, aircraft or other objects from attack or punctiform loading or for protecting satellites from mechanical destruction.

The ceramic antiballistic layer according to the invention has a continuous surface on the side facing the attack, whereas the surface facing away from the attack is distinguished by a segmented structure which, starting from this surface, extends into the interior of the protective layer but does not penetrate all the way through the layer as far as the opposite surface, which faces the attack. The segment structure is produced either through the use of material-removing processes or through the use of material-displacing processes or through the use of spacers. Alternatively, a segmented structure which starts from one side and does not continue through the entire thickness of the layer is obtainable by two layers, which are securely joined to one another and the coefficients of thermal expansion of which are different, being produced in a process which takes place at elevated temperature, so that during the subsequent cooling phase cracks are formed in the layer made from the material having the higher coefficient of thermal expansion, dividing this layer into individual segments, whereas the adjacent layer made from the material having the lower coefficient of thermal expansion remains crack-free.

Single-sided crack formation during drying to produce the protective layer according to the invention can also be exploited. This variant is possible both with a two-layer structure and with a homogenous structure.

Although the text which follows describes the protective layer according to the invention predominantly with regard to the aspect of using it to protect against attack, the invention is not restricted to this intended use. The protective layer according to the invention is also suitable for providing protection against other mechanical loads with a punctiform action. Therefore, in the description which follows, the term “attack” is merely to be understood as one example of such loads.

Other features which are considered as characteristic for the invention are set forth in the appended claims.

Although the invention is illustrated and described herein as embodied in a ceramic antiballistic layer, a process for producing the layer and a protective device having the layer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a protective layer according to the invention as seen from a direction of attack P;

FIG. 2 is a perspective view of a protective layer according to the invention as seen from a side facing away from the attack;

FIG. 3 is an enlarged, partly cut-away, perspective view of a protective layer according to the invention as shown in FIG. 2; and

FIG. 4 is an enlarged, partly cut-away, perspective view of a further embodiment of the protective layer according to the invention.

### DESCRIPTION OF THE PREFERRED EMBODIMENTS

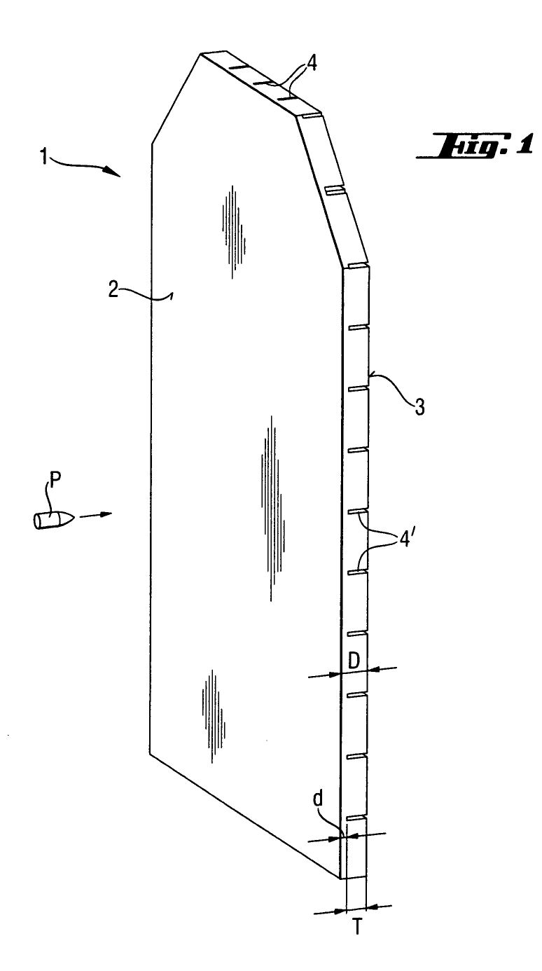

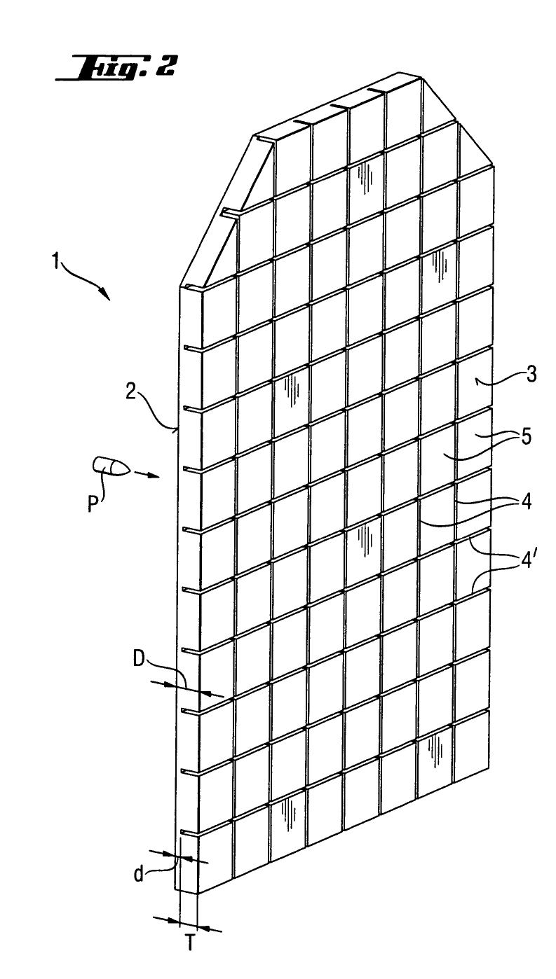

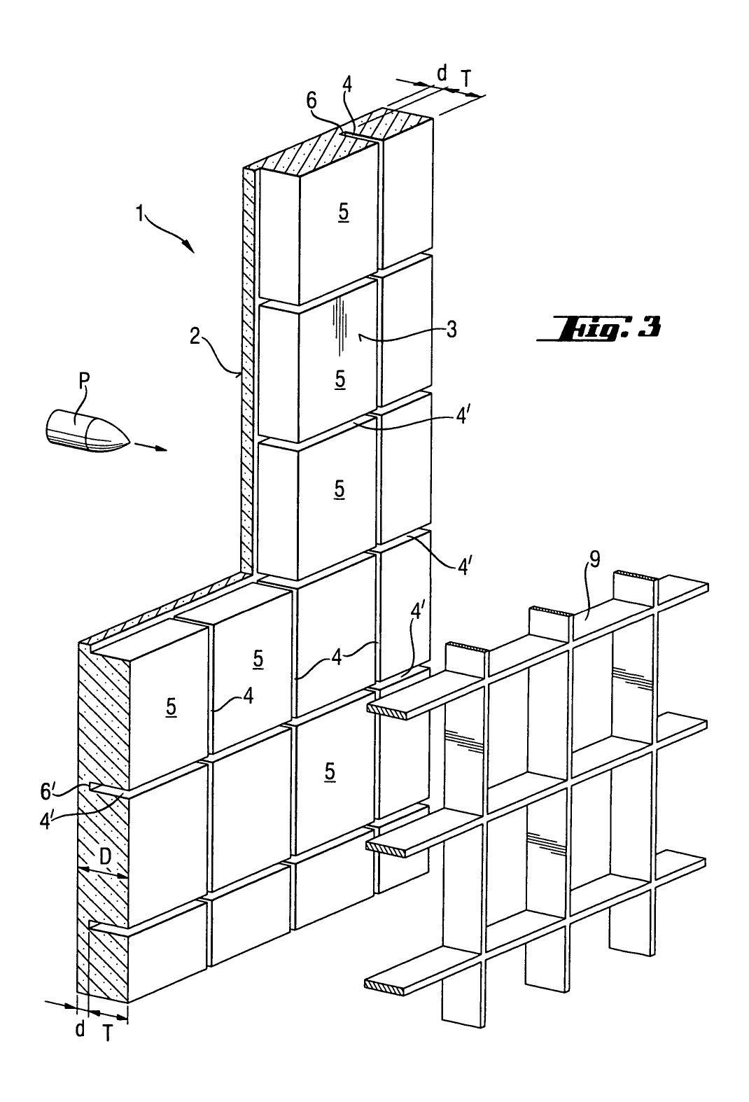

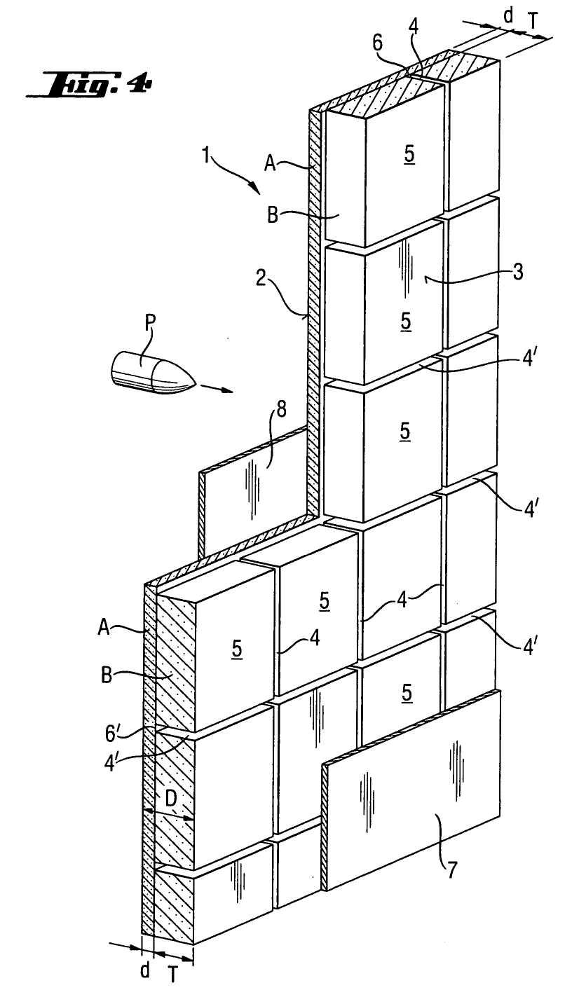

Referring now initially to FIGS. 1 to 4 of the drawings as a whole, there is seen an antiballistic layer 1 according to the invention, which is approximately 5 to 150 mm thick in total. The layer 1 has a continuous surface 2 on a side facing an attack P, whereas a surface 3 facing away from the attack is distinguished by a segmented structure. The segmented structure, starting from this surface 3, extends into the interior of the protective layer 1 but does not penetrate through as far as the opposite surface 2, which faces the attack. In other words, a depth T of gaps 4, 4′ between individual segments 5 (see FIGS. 2-4) from which the side 3 facing away from the attack is formed, is less than a thickness D of the protective layer 1. In order to ensure that the protective layer 1 according to the invention functions reliably and retains its stability, the depth T of the gaps 4, 4′ between the segments 5 should be at least 0.15 mm less than the thickness D of the entire layer. In other words, material with a thickness d of at least 0.15 mm must remain in place between bases 6, 6′ (see FIGS. 3-4) of the gaps 4, 4′ and the surface 2 which faces the attack. The dimensions of the individual segments 5 are between 5 mm×5 mm and 250 mm×250 mm. Segments with dimensions of between 10 mm×10 mm and 150 mm×150 mm are preferred. As has already been described, larger segments are unsuitable for protecting against a multi-hit attack spaced apart by a short distance at the target, whereas production costs increase greatly for smaller segments. The width of the gaps between the individual segments is between a few μm, if the gaps are obtained in the form of cracks resulting from different thermal expansion or during drying, and in the 1/10 mm range if they are produced through the use of machining processes, but at any rate should not exceed 5 mm.

The invention is not linked to any specific shape of the segments 5. By way of example, the segments may be square, rectangular, parallelogram-shaped, polygonal, in honeycomb form, circular or elliptical. Free-form shapes with irregular, for example meandering, contours are also possible, but a complicated shape increases the manufacturing costs and/or the demands imposed on machines and tools used for this purpose.

The segmented surface of the protective layer according to the invention, which is the surface facing away from the attack, may rest on a backing layer 7 shown in FIG. 4 which serves to trap projectile fragments (splinters, pieces) and to reduce residual energy. The structure and production of backings of this type are known in the specialist field. Examples of suitable materials for production of backings of this type include metal, aramid fabric or Dyneema fabrics.

For the invention to function, it is not absolutely imperative that the continuous, unsegmented surface of the protective layer according to the invention be directly exposed to the attack. If appropriate, that surface of the antiballistic layer according to the invention which faces the attack may be covered with one or more further covering layers 8 shown in FIG. 4, for example ceramic layers. In principle, an outer layer of this type may also be produced from individual tiles, but this variant is not preferred due to the economic drawbacks mentioned in the introduction.

The only crucial factor for the protective layer according to the invention to function is that the surface 2 of the protective layer according to the invention which is closer to the attack (i.e. the surface which faces the attack), unlike the rear surface 3, facing away from the attack, of the protective layer, is not segmented.

The protective layer according to the invention contains at least one ceramic material. The production of materials of this type is known in the specialist field. Materials which are suitable for protective layers according to the invention are both oxidic ceramics, such as aluminum oxide and zirconium oxide, and nonoxidic ceramics, such as boron carbide, boron nitride in one of the diamond-like high-temperature modifications, silicon nitride, silicon carbide and silicon-infiltrated silicon carbide (SiSiC). Fiber-reinforced ceramics, such as aluminum oxide reinforced with aluminum oxide fibers, silicon carbide reinforced with silicon carbide fibers (SiC/SiC) or silicon carbide reinforced with carbon fibers (C/SiC), are particularly suitable. Silicon carbide reinforced with carbon fibers is particularly preferred for the production of the protective layers according to the invention, since siliciding—unlike the shrinkage of material during sintering of conventional ceramics—produces only relatively minor shape changes, and consequently highly accurate contours can be achieved. This is particularly advantageous when producing free-form components, for example curved components.

In a variant of the antiballistic layer according to the invention, the gaps between the segments are filled with a metal and/or a plastic and/or a ceramic material. In this case, the composition of the material in the gaps differs from the material of which the segments are formed in such a way that the gap-filling material is different than the material which forms more than 50% by volume of the composition of the segments. For example, if the segments are formed of a silicided ceramic, this material also contains free silicon, but in an amount of less than 50% by volume. Therefore, in a protective layer according to the invention formed from silicided ceramic, the gaps between the individual segments can be completely or partially filled with metallic silicon. “Partially filled” means that it is not the entire volume of the gaps which is filled with the corresponding material. In a first variant of the invention illustrated in FIGS. 1 to 3, the protective layer 1 according to the invention is composed homogenously of one of the above-mentioned materials and is provided with a segment structure starting from the surface 3 through the use of one of the processes according to the invention. The gaps 4, 4′ between the individual segments 5 do not extend through the entire thickness of the layer 1. In a second variant, which is illustrated in FIG. 4, the layer 1 according to the invention includes first and second layers A and B which rest one on top of the other and are fixedly joined to one another. The first layer A faces the attack and the second layer B faces away from the attack. The layer A has a continuous surface 2 without any segmentation and gaps on its side which faces outward, toward the attack, whereas the surface 3 of the layer B which faces outward, away from the attack, is segmented. The gaps 4, 4′ which delimit the individual segments 5, extend at most through the entire thickness of the layer B to an interface with the layer A. The compositions of the layers A and B may differ. By way of example, the layer A, which is intended for the side facing the attack, may be formed of fiber-reinforced ceramic, whereas the layer B, which faces away from the attack and is to be provided with the segmented structure, may be formed of a ceramic material without fiber reinforcement or with a lower proportion by volume of reinforcing fibers. In this embodiment, the layer A facing the attack contains up to 60% by volume of reinforcing fibers, whereas in the layer B which faces away from the attack the reinforcing fibers form at most 45% by volume. It is particularly preferable for the reinforcing fibers to form less than 50% by volume of the layer A and less than 20% by volume of the layer B. The proportion of the ceramic material in the fiber-reinforced layer B facing away from the attack is at least 55% by volume. In addition to the matrix-forming ceramic material and the reinforcing fibers, the material formulations for the two layers may also contain binders, such as resins, preferably pyrolyzable binders and if appropriate residues of free carbide-forming metals, e.g. if the ceramic is silicided.

In a further embodiment, the layer B intended for the side facing away from the attack is formed of a material with a higher coefficient thermal expansion than that of the material forming the layer A intended for the side which faces the attack. The layers having the different coefficients of thermal expansion are produced in a process which takes place at elevated temperature. During cooling following the treatment at elevated temperature, for example after the siliciding, cracks are formed in the layer having the higher expansion coefficient and divide this layer into segments. The cracks extend at most through the entire thickness of the layer B as far as the interface with the layer A, which for its part remains crack-free and is intended for the side which faces the attack.

By way of example, the layers A and B may be formed of carbonizable molding compounds reinforced with carbon fibers, having a fiber content being higher in the layer A than in the layer B. If this body including the layers A and B which have been reinforced with different levels of fibers is then infiltrated with liquid silicon, the conversion to silicon carbide in the layers A and B proceeds to different extents. The lower the fiber content, the higher the degree of siliciding and the conversion to silicon carbide. The coefficients of thermal expansion of the layers A and B which have been silicided to different extents differ. Due to the higher degree of siliciding, the thermal expansion of the layer B is greater, so that during cooling cracks are formed leading to segmentation of this layer, whereas the layer A remains continuous. The crack formation can be controlled deliberately through the use of the degree of siliciding or degree of conversion.

The fiber reinforcement of the ceramic matrix can be obtained by short fibers introduced into the molding compound in the desired quantity. However, the layer facing the attack can also be reinforced through the use of a woven fabric introduced into the ceramic matrix, for example a woven carbon fiber fabric. Felts of carbon fibers or carbonizable products (e.g. pressboards) of cellulose fibers are suitable for the fiber reinforcement of the layer that faces away from the attack and is to be segmented. These cellulose fibers are likewise carbonized during the carbonization of the molding compound. Separate carbonization of the individual layer materials and the subsequent joining of these materials prior to the final high-temperature treatment is also a practical option.

The segmentation of the layer according to the invention is carried out either at a suitable intermediate stage of the production process or as the final process step.

The segment structure on the surface facing away from the attack is producible, for example, by material-removing processes, such as milling, sawing, grinding, erosion, burning, laser-beam cutting, water-jet cutting or the like. One of these processes is used to remove material from the side facing away from the attack in accordance with the desired segment structure, so that individual islands of material—the segments 5—remain in place, with narrow gaps 4, 4′ from which the material has been removed extending between these islands of material. These processes are employed when the ceramic body has already been consolidated, i.e. after drying or after sintering of the green body.

If the protective layer according to the invention is to be produced from silicided ceramic, the material-removing structuring is carried out either before or after the siliciding. The starting material which has not yet been silicided can be processed more easily and using simpler measures than the silicided end product. However, segmentation carried out prior to the siliciding has the drawback that the subsequent infiltration with liquid silicon may also cause the gaps between the segments to be at least partially filled with silicon. This drawback is avoided if the gaps are filled and blocked by spacers, for example materials which can be washed out, during siliciding, and these spacers are removed after the siliciding. The fully silicided product may alternatively be structured on one side, for example through the use of erosion or laser beam cutting.

Furthermore, a segment structure according to the invention can be obtained by material-displacing processes, for example by the segment structure being stamped, imprinted or pressed into the surface which faces away from the attack. This may be carried out, for example, through the use of a suitably structured ram or press tool.

Another material-displacing process which is suitable for the production of a segment structure is cutting in which the surface facing away from the attack is segmented by being cut into.

A further method for segmenting the surface facing away from the attack resides in introducing spacers into this surface when the ceramic material is still deformable. These spacers are, for example, cast, placed or pressed into the surface. The spacers are introduced into the surface in a pattern which corresponds to the profile of the gaps between the segments that are to be produced. It is preferable to use web-like spacers 9 as shown in FIG. 3 which form a grid, for example an orthogonal grid. When the material has adopted a consolidated state, the spacers are removed again, leaving behind recesses in the surface. By way of example, the spacers 9 may be taken away after the ceramic material has dried. Then, the ceramic material is sintered. The sintering process is associated with a certain shrinkage, the extent of which is dependent on the composition of the ceramic material. This advantageously reduces the width of the gaps 4, 4′.

In a variant of this process, the spacers are formed of a sacrificial material, i.e. a material which can be dissolved or chemically or thermally destroyed, for example pyrolyzed or burnt, and are removed from the consolidated material during one of the subsequent steps of the production process, for example a heat treatment or by treatment with a solvent. By way of example, spacers made from a material which can be pyrolyzed virtually without leaving any residues, such as polyvinyl alcohol, polyvinyl acetate, polymethyl methacrylate or polymethyl methacrylimide, are introduced into the surface which is to be segmented. These spacers are pyrolyzed during sintering and leave behind recesses in the surface. Alternatively, spacers which are formed of a material that is burnt out during the high-temperature treatment may be used. Material-removing, material-displacing and spacer-based segmentation processes can be used both for the production of protective layers according to the invention with a homogenous structure as shown in FIGS. 1 to 3 and for the production of two-layer protective layers as shown in FIG. 4. In the case of two-layer protective layers, the layer B, which is intended for the side facing away from the attack, is processed using one of the above-mentioned processes, resulting in a segment structure.

A further method for providing a segmented structure on one side of protective layers having a two-layer structure according to the invention can be employed if, at elevated temperature, it is possible to produce the two layers A and B, which bond to one another and have different coefficients of thermal expansion. The layer A which is intended for the side facing the attack has the lower coefficient of thermal expansion. If a protective layer according to the invention which has been constructed in this way is cooled following a heat treatment step, for example after sintering or siliciding, cracks are formed in the layer B of the material having the higher expansion coefficient, dividing this layer into segments. The cracks pass through the layer B at most as far as the interface with the layer A, which for its part, due to its lower thermal expansion, remains crack-free. The result is an antiballistic layer according to the invention having a surface facing the attack which is continuous, where the surface facing away from the attack has been structured into individual segments delimited by the cracks.

Crack formation which occurs only on one surface of a homogenous protective layer or only in a layer B of a two-layer protective layer, can also be used during the drying process of the ceramic material to produce an antiballistic layer according to the invention. The formation of cracks on one side is caused, for example, by the green body being heated to a greater extent from one side than the other during drying.

The protective layer according to the invention is suitable for protecting people, vehicles and aircraft as well as other objects from attack even in the event of a multi-hit attack spaced apart by a short distance at the target, or other types of mechanical loading with a punctiform action. A further application for the protective layer according to the invention relates to protecting satellites from mechanical destruction.

### Exemplary Embodiments

### EXAMPLE 1

A grid-like web system is introduced into a casting mold. This web system is fixed at a distance of approximately 1 mm above a base of the mold. The webs which form the grid are at a distance of approximately 20 mm from one another, have a height of approximately 20 mm and form an orthogonal grid. The wall thickness of the webs is less than 1 mm.

A sinterable ceramic material is cast into a mold which has been prepared in this manner. The distance between the grid and the mold base results in automatic leveling of the liquid material. After drying at a temperature of over 80° C., the webs can be removed. The green body formed in this way has a surface which is continuous on one side, whereas the opposite surface is segmented in a pattern corresponding to the system of webs.

Green bodies of this type can be sintered in a known way. Due to the shrinkage of the material during sintering, the width of the gaps which remained after the removal of the system of webs is reduced, advantageously to a range of from approximately 0.1 to 0.3 mm.

### EXAMPLE 2

The mold is prepared and filled as in Example 1, but the system of webs is formed of a material which can be pyrolyzed without leaving residues, after drying initially remains in the green body and is completely pyrolyzed during the subsequent high-temperature process, leaving behind gaps 4, 4′ which surround segments 5.

### EXAMPLE 3

A sinterable ceramic material is added to a mold and pre-dried to give a green body. Then, corresponding segmentation is introduced by stamping in a pattern, for example through the use of a press tool or ram with a grid-like structure, or by cutting. The segmented structure produced in this way does not penetrate through the opposite surface. A green body which has been prepared in this manner is sintered in a known way.

### EXAMPLE 4

A porous body formed from carbon reinforced with carbon fibers (C/C) having a total thickness of 8 mm is cut into on one side using a cutting device in such a way that the cuts form a grid-like pattern. The depth of cut is at most 7.5 mm. The cuts are narrower than 1 mm. The cuts were introduced orthogonally, at a distance of 20 mm from one another in each case.

Then, the cuts were provided with a filling of boron nitride (hexagonal modification), and the porous body of carbon reinforced with carbon fibers (C/C) was infiltrated with liquid silicon under an inert atmosphere or under shielding gas. The filling of the gaps with boron nitride prevents them from filling up with silicon. In this sense, boron nitride functions as a spacer during the siliciding process, which is then removed by being washed out.

After final cleaning, the result was a plate of C/SiC with a continuous surface on one side and a corresponding segmented structure on the opposite side.

### EXAMPLE 5

An approximately 4 mm high layer of carbonizable molding compound reinforced with short fibers in a proportion by volume of 50% of carbon fibers is introduced into a mold (layer A). A second layer (layer B) of a carbonizable molding compound reinforced with short fibers in a proportion by volume of 20% of carbon fibers is applied to the layer A, and the two layers are pressed together. After the pressing operation, the first layer (layer A) has a thickness of from approximately 1 to 1.5 mm, and the overall pressed body has a height of approximately 14 mm. It is then carbonized at approximately 900° C.

The molding compounds of the two layers are converted to silicon carbide to different extents during the subsequent siliciding, due to their different fiber contents. The molding compound with the higher fiber content, the degree of conversion of which is lower, forms a continuous layer A intended for the side facing the attack. Due to the higher coefficient of thermal expansion of the more highly silicided material in the layer B, cracks are formed in this layer during cooling, and the cracks propagate transversely through this layer as far as the interface with the layer A. The surface of the layer B which has been segmented by the crack structure is intended for the side facing away from the attack.

### EXAMPLE 6

As described in Example 5, a protective layer including two ceramic layers A and B with different degrees of siliciding and reinforced with carbon fibers is produced. However, the matrix in the first layer (layer A) is reinforced not with short fibers, but rather with a woven carbon fiber fabric.

### EXAMPLE 7

As described in Example 5, a protective layer including two ceramic layers A and B with different degrees of siliciding and reinforced with carbon fibers is produced. However, in the second layer (layer B) the fibers are in the form of a carbon fiber felt.

### EXAMPLE 8

As described in Example 5, a protective layer including two ceramic layers A and B with different degrees of siliciding and reinforced with carbon fibers is produced. However, the molding compound used to produce the layer B does not contain any carbon fibers, but rather contains cellulose fibers which are also carbonized during the carbonizing of the molding compound.

### EXAMPLE 9

A shaped body is produced from wood dust and a pyrolyzable binder. Saw cuts with a width of approximately 0.5 mm (saw blade width) and disposed orthogonally to one another at intervals of 15 mm are introduced into this shaped body in such a manner that the cut depth is approximately 2 mm less than the component thickness. The side facing away from the saw blade is therefore not cut through.

During the subsequent pyrolysis, the volume shrinks by approximately 50%. This changes the gap dimensions of the sawn cuts to approximately 50% of their original width. These reduced gap widths are retained during the subsequent siliciding.

This application claims the priority, under 35 U.S.C. § 119, of German Patent Application 03 027 067.3, filed Nov. 25, 2003; the entire disclosure of the prior application is herewith incorporated by reference.

1. An antiballistic layer, comprising:
at least one ceramic material;
a layer thickness;
a side intended to face toward an attack, said side intended to face toward the attack having a continuous surface; and
a side intended to face away from the attack, said side intended to face away from the attack having a segmented surface composed of individual segments delimited by gaps, said gaps having a depth between said segments being at least 0.15 mm less than said layer thickness.

2. The antiballistic layer according to claim 1, wherein said segments have a shape selected from the group consisting of square, rectangular, parallelogram, polygonal, honeycomb, circular, elliptical and meandering-contoured.

3. The antiballistic layer according to claim 1, which further comprises a material forming at least 50% by volume of said segments, and a material selected from at least one of the group consisting of a metal, a plastic and a ceramic at least partially filling said gaps between said segments and being different than said material forming at least 50% by volume of said segments.

4. The antiballistic layer according to claim 1, which further comprises a protective backing on which said segmented surface facing away from the attack rests, and a covering layer provided on said continuous surface.

5. The antiballistic layer according to claim 1, which further comprises a protective backing on which said segmented surface facing away from the attack rests.

6. The antiballistic layer according to claim 1, which further comprises a covering layer provided on said continuous surface.

7. The antiballistic layer according to claim 1, wherein said at least one ceramic material is from the class of nonoxidic ceramics.

8. The antiballistic layer according to claim 1, wherein said at least one ceramic material is from the class of oxidic ceramics.

9. The antiballistic layer according to claim 1, wherein said at least one ceramic material is selected from at least one of the group consisting of aluminum oxide, zirconium oxide, boron carbide, silicon carbide, silicon-infiltrated silicon carbide, diamond-like high-temperature modifications of boron nitride and silicon nitride.

10. The antiballistic layer according to claim 1, wherein said at least one ceramic material is from the class of fiber-reinforced ceramic.

11. The antiballistic layer according to claim 10, wherein said fiber-reinforced ceramic is a material selected from the group consisting of silicon carbide reinforced with carbon fibers, silicon carbide reinforced with silicon carbide fibers and aluminum oxide reinforced with aluminum oxide fibers.

12. The antiballistic layer according to claim 1, wherein said at least one ceramic material is formed of first and second layers of ceramic materials securely joined to one another, said first layer faces toward the attack and said second layer faces away from the attack, said first layer has said side intended to face toward the attack having said continuous surface and facing outward, and said second layer has said side intended to face away from the attack having a segment structure with said segmented surface composed of said individual segments delimited by said gaps and facing outward.

13. The antiballistic layer according to claim 12, wherein said first layer facing the attack contains a fiber-reinforced ceramic.

14. The antiballistic layer according to claim 12, wherein said first and second layers both contain fiber-reinforced ceramics, a proportion by volume of fibers in a layer composition being greater in said first layer than in said second layer, a proportion by volume of the fibers in said first layer being at most 60%, and a proportion by volume of said at least one ceramic material in said second layer being at least 55%.

15. The antiballistic layer according to claim 12, wherein said first layer facing the attack is formed of a material having a coefficient of thermal expansion being lower than that of a material of which said second layer facing away from the attack is formed.

16. The antiballistic layer according to claim 12, wherein said first and second layers are formed of silicon carbide reinforced with carbon fibers, a proportion by volume of carbon fibers in a layer composition being higher in said first layer than in said second layer, and said second layer having a higher silicon carbide content than said first layer.

17. The antiballistic layer according to claim 16, wherein said first layer contains a woven carbon fiber fabric and said second layer contains a carbon fiber felt or a product obtained by carbonization of cellulose fibers.

18. The antiballistic layer according to claim 16, wherein said first layer contains a woven carbon fiber fabric.

19. The antiballistic layer according to claim 16, wherein said second layer contains a carbon fiber felt or a product obtained by carbonization of cellulose fibers.

20. A process for producing an antiballistic layer, the process which comprises:
producing said gaps between said segments at said segmented surface in the antiballistic layer according to claim 1 by a material-removing process at an intermediate stage of a production process or in a final process step.

21. A process for producing an antiballistic layer, the process which comprises:
introducing said gaps into said segmented surface in the antiballistic layer according to claim 1 by cutting at an intermediate stage of a production process or in a final process step.

22. A process for producing an antiballistic layer, the process which comprises:
forming said gaps in said segmented surface in the antiballistic layer according to claim 1 by a step selected from the group consisting of stamping, imprinting and pressing.

23. A process for producing an antiballistic layer, the process which comprises:
inserting, pressing or casting spacers into still-deformable ceramic material at locations at said surface to be segmented at which said gaps are to be produced in the antiballistic layer according to claim 1;
consolidating the ceramic material; and
removing the spacers.

24. The process according to claim 23, which further comprises forming the spacers of a sacrificial material, and carrying out the step of removing the spacers from the consolidated ceramic material by a step selected from the group consisting of combustion, pyrolysis, chemical or thermal decomposition and dissolution of the sacrificial material.

25. A process for producing an antiballistic layer, the process which comprises:
producing a structure of said segmented surface of the antiballistic layer according to claim 1 by forming cracks on one side of a green body as the green body dries.

26. A process for producing an antiballistic layer, the process which comprises:
joining said first and second layers of ceramic materials having different coefficients of thermal expansion of the antiballistic layer according to claim 15 in a process taking place at elevated temperature, the material of said second layer having a higher coefficient of thermal expansion than the material of said first layer; and
cooling the antiballistic layer immediately after the first and second layers have been joined, forming segmenting cracks in said second layer.

27. A protective device, comprising:
the antiballistic layer according to claim 1 for protecting people, vehicles, aircraft or other objects from attack or punctiform loading.

28. A protective device, comprising:
the antiballistic layer according to claim 1 for protecting satellites from mechanical destruction.
